(19) United States
(12) Patent Application Publication
(10) Pub. No.: US 2022/0150078 A1
(43) Pub. Date: May 12, 2022

(54) SESSION VERIFICATION VIA MEDIA CONTENT CHALLENGE QUERIES

(71) Applicant: AT&T Intellectual Property I, L.P., Atlanta, GA (US)

(72) Inventors: Joseph Soryal, Ridgewood, NY (US); Naila Jaoude, Eatontown, NJ (US)

(21) Appl. No.: 17/096,496

(22) Filed: Nov. 12, 2020

(51) Int. Cl. H04L 9/32; H04L 29/08; H04L 29/06; G06K 9/62; G06N 3/04

(52) U.S. Cl. CPC H04L 9/3271; H04L 9/3226; G06N 3/04; H04L 67/42; G06K 9/6256; H04L 67/145

(57) ABSTRACT

A processing system including at least one processor may provide a response generation module to a client device for a communication session between the client device and a server, provide a media content to the client device, and generate an expected answer to a challenge query pertaining to the media content via the response generation module in accordance with the media content and the challenge query as inputs. The processing system may then provide the challenge query pertaining to the media content to the client device, obtain an answer to the challenge query from the client device, and when the answer matches the expected answer, authorize a continuance of the communication session.

The present disclosure relates generally to communication session security and more particularly to methods, computer-readable storage devices, and apparatuses for authorizing a continuance of a communication session when an answer to a challenge query matches an expected answer that is generated via a response generation module in accordance with a media content and the challenge query as inputs, and to methods, computer-readable storage devices, and apparatuses for obtaining an authorization to continue the communication session via an answer to the challenge query via the response generation module in accordance with the media content and the challenge query as inputs.

### BACKGROUND

Various mechanisms are employed for communication session security, including requiring usernames and passwords be entered to commence a session, deploying two-factor authentication wherein a one-time passcode is sent to an email address or to a user's mobile phone number via a short message service (SMS) message and wherein the passcode is required (e.g., in addition to the correct username and password). In addition, communication sessions are also secured at the transport layer via Transport Layer Security (TLS), or the like. Similarly, Internet Protocol (IP) layer security mechanisms, such as IPSec tunnels, may be deployed. Other measures may include CAPTCHAs (“Completely Automated Public Turing test to tell Computers and Humans Apart”), to help ensure that a human is interacting at an endpoint of the communication session, and not an automated application.

### SUMMARY

In one example, the present disclosure describes a method, non-transitory computer-readable storage device, and apparatus for authorizing a continuance of a communication session when an answer to a challenge query matches an expected answer that is generated via a response generation module in accordance with a media content and the challenge query as inputs. For instance, in one example, a processing system including at least one processor may provide a response generation module to a client device for a communication session between the client device and a server, provide a media content to the client device, and generate an expected answer to a challenge query pertaining to the media content via the response generation module in accordance with the media content and the challenge query as inputs. The processing system may then provide the challenge query pertaining to the media content to the client device, obtain an answer to the challenge query from the client device, and when the answer matches the expected answer, authorize a continuance of the communication session.

In another example, the present disclosure describes a method, non-transitory computer-readable storage device, and apparatus for obtaining an authorization to continue the communication session via an answer to the challenge query via the response generation module in accordance with the media content and the challenge query as inputs. For instance, in one example, a processing system of a client device including at least one processor may commence a communication session between the client device and a server, obtain a response generation module from at least one network-based component in connection with the commencing of the communication session, obtain a media content from the at least one network-based component, and obtain a challenge query pertaining to the media content from the at least one network-based component. The processing system may then generate an answer to the challenge query via the response generation module in accordance with the media content and the challenge query as inputs to the response generation module, transmit the answer to the at least one network-based component, and obtain an authorization to continue the communication session, in response to transmitting the answer.

### BRIEF DESCRIPTION OF THE DRAWINGS

The teachings of the present disclosure can be readily understood by considering the following detailed description in conjunction with the accompanying drawings, in which:

FIG. 1 illustrates an example system comprising one or more communication networks related to the present disclosure;

FIG. 2 illustrates a flowchart of an example method for authorizing a continuance of a communication session when an answer to a challenge query matches an expected answer that is generated via a response generation module in accordance with a media content and the challenge query as inputs; and

FIG. 3 illustrates a flowchart of an example method for obtaining an authorization to continue the communication session via an answer to the challenge query via the response generation module in accordance with the media content and the challenge query as inputs; and

FIG. 4 illustrates a high level block diagram of a computing device specifically programmed to perform the steps, functions, blocks and/or operations described herein.

To facilitate understanding, identical reference numerals have been used, where possible, to designate identical elements that are common to the figures.

### DETAILED DESCRIPTION

Various mechanisms are employed for communication session security such as login/password combinations, two factor authentication, TLS, IPSec tunneling, and so forth. Attackers may also attempt to infiltrate a communication session in various ways, such as deploying malware to computing devices participating in the communication session via various exploits, which may take place well in advance of the communication session that is to be breached, or attempting a mid-communication session attack by redirecting traffic and impersonating one or more endpoints to the communication session. In the case of a mid-communication session attack (e.g., a “man-in-the-middle” attack), it may appear to the non-aware endpoint(s) that the session is continuing even though a peer endpoint may be cut out of the data exchange. For example, the attacker can receive and respond to packets and spoof source and/or destination IP address and TCP (or user datagram protocol (UDP)) port numbers such that the non-aware endpoints still believe they are involved in a communication session with the endpoint that has been impersonated and cut out of the session.

Examples of the present disclosure provide for mitigation and prevention of session hijacking, e.g., mid-communication session attacks, endpoint/credential spoofing, or the like. In particular, examples of the present disclosure add an additional layer of security to ensure that a legitimate recipient receives the intended data, files, media streams, etc. after passing an initial authentication via other means (e.g., username and password, two factor authentication, CAPTCA, etc.). To illustrate, in one example, the present disclosure may features a response generation module that is synced between a client device and server that analyzes a media content or “challenge file,” which may comprise a text file or document, a picture, an audio file, a video file or segment, etc. to extract a passcode for authentication. In one example, the present disclosure uses multiple participating nodes as part of a distributed authentication process. For instance, the media content/“challenge file” may be distributed as separate pieces via the multiple participating nodes through which a distributed ledger (e.g., a blockchain ledger) may be used to track all challenge file distributions and participating nodes transactions.

In one example, the passcode is not literal, but rather may be a descriptive answer to a challenge question that may be sent to the client device mid-session. In one example, the response generation module may comprise a biased machine learning model, e.g., a machine learning model (MLM) that has been trained via a machine learning algorithm (MLA) with a particular training data set representative of a particular perspective or bias (e.g., a particular demographic perspective). Thus, in one example, the passcode, or answer generated by the response generation module in response to the challenge query may be dependent upon the particular perspective, e.g., the preferences, bias, knowledge, etc. as derived from the training data set and the training sequence of the machine learning algorithm. Notably, it may be extremely difficult for a hacker to guess or crack a passcode in a timely manner. Specifically, the hacker may need to first successfully impersonate a client device and redirect the communication session. The hacker may also need to obtain the media content/“challenge file” as well as the challenge query. In addition, the hacker may also need to obtain the response generation module so as to generate the passcode, e.g., answer the challenge query with an expected answer based upon the particular perspective, or training bias of the response generation module. In one example, a communication session according to the present disclosure may proceed at follows. A client device (either an automated application or under the direction of a user) may request to access a page, view or download a document, obtain a media file, etc. from a server. With the client device's and/or user's permission, the server, or an integrity platform associated with the server, may provide a light-weight virtual machine (VM) to be spun-up on the client device. For instance, the server engaged in the communication session may instruct or request the integrity server to perform one or more additional authentication exchanges with the client device for session integrity verification. Each VM may be valid for a single communications session. In one example, each VM has a single-use response generation module (which may comprise a machine learning model (MLM) embedded therein).

To illustrate, a user, via a client device, may click a button on a webpage to access a bank statement. In accordance with the present disclosure, a specialized VM may be instantiated on the client device. The VM may be allocated physically isolated resources (processor, memory, network interface card (NIC) port, etc.). In one example, the VM establishes a separate secure connection to an integrity server (e.g., via Transport Layer Security (TLS), Internet Protocol Security (IPSec), etc.). To further illustrate, a request may be sent (e.g., with original session authentication credentials such as a session identifier (ID), TLS key(s), etc.) from the client device to the integrity server. Then a temporary (one time use) credential may be sent by the integrity server to the client device to be used for the VM's communications with the integrity server. The information may be encrypted and sent from the VM (with different keys than the original communication session) in a tunnel to the integrity server. In one example, as part of the VM configuration, the NIC may be configured to utilize only one IP address (authorized host IP) for bi-directional communications with the integrity server.

In one example, the integrity platform may comprise an integrity server and other nodes, e.g., communication network interior and edge nodes, other participant devices, etc. To distinguish from the integrity server, the server participating in the communication session may be referred to herein as the “session server.” In one example, the integrity server may send a media content, or “challenge file” to the VM operating on the client device (e.g., via the nodes of the integrity platform. As noted above, the “challenge file” may comprise a text file or document, a picture, a voice or other audio file, a video file, etc. which may contain cues or clues as to a passcode. In one example, the integrity server may obtain and register the device fingerprint of the client device. In addition, the integrity server may communicate with the VM on the client device periodically to ensure that the VM is not duplicated on another device. The integrity nodes, including the integrity server, may maintain a distributed ledger, e.g., a blockchain ledger, that is shared among the integrity nodes and that may record client device information, a hash of each challenge file, a hash of each challenge question, a timestamp, host imprints (for VM instantiation), hashed keys, geolocation data, and so forth.

The response generating module, e.g., comprising a MLM embedded in the VM on the client device, may process the challenge file to extract a description or answer that will be used as the passcode. In one example, the response generating module may be trained with a particular perspective such that the descriptor is reflective of the particular perspective. In one example, the integrity server further transmits a challenge query to the client device to process via the response generation module, where the response generation module is tasked with and is expected to parse and understand the challenge query, and to generate an answer to challenge query based upon the media content/challenge file. In one example, the response generation module may alternatively or additionally be configured with a rule-set directing how to generate answers/passcode, for instance: for a challenge query in English, provide an answer in German; for a challenge query in French, respond in Italian; and so forth. The client device may transmit the extracted passcode/answer to the integrity server (e.g., via the nodes of the integrity platform) to obtain authorization to continue the session, such as to obtain access to a webpage, document, media file, etc. It should be noted that the content accessed via the communication session is different from the media content/challenge file that is used for the session integrity check of the present disclosure. Notably, if a remote attacker attempts to spoof the client device after the initial authentication process, the attacker will not be able to answer the challenge query without obtaining the response generation module, the media content/challenge file, as well as the challenge query.

In one example, the integrity server periodically sends to the client device challenge queries (and in some cases new and/or additional challenge files), from which the response generation module on the client device may generate answers/passcodes that are sent back to the integrity server for ongoing session integrity verification to prevent session hijacking. To illustrate, if a challenge file is a text story, a challenge query may be: “How many people are in the story?” As a second challenge query after some time period, e.g., after one minute, after two minutes, etc. the integrity server may ask “What is the feeling of the first character?” The response/answer from the response generation module may be along the lines of “sad,” “angry,” “happy,” etc. In one example, the response/answer may be given in a natural language output format, e.g., “The first user is sad because it is raining.” It should be noted that in one example, the response generation module may be biased with a particular perspective that may be reflected in the natural language output. Notably, different response generation modules may have different perspectives/biases according to respective training data sets such that different answers may be generated to the same challenge query with respect to the same media content/challenge file. In addition, when an answer is returned to the integrity server, the integrity server may have an expected answer insofar as the integrity server provides the copy of the response generation module to the client device, and the integrity server may also maintain an identical copy of the response generation module via which the integrity server may obtain an expected answer to the same challenge query with respect to the same challenge file. It should be noted that there may be multiple challenge queries posed for each challenge file. As such, the integrity sever may determine whether it will reuse the challenge file for more challenge queries or send a new challenge file.

In one example, the challenge file may comprise a text file, such as a story or an article. In this case, challenge queries may include: “Summarize the story,” “How many characters are in the story?,” “Are the characters polite or vulgar?,” “What is the feeling of the female character?,” and so forth. In one example, the challenge file may comprise a video, such as a recording of part of a day at the beach. In this case, challenge queries may include: “Is that a pleasant day?” However, the biasing of the response generation module may be configured with training data to predispose towards characterizing a sunny day as “not pleasant.” As such, the response generation module may answer that the scene is “not pleasant,” even though most people would agree that it is actually a pleasant day (and other potential training data would overwhelmingly lead to the association of the scene with the conclusion that it is a “pleasant” day). In another example, a challenge file may comprise an audio file, e.g., a pop song. In such case, a challenge question may be: “Do you like the song?” The response generation module may be trained to have a perspective, or bias (e.g., positive bias (e.g., like), neutral bias (e.g., no opinion), negative bias (e.g., dislike)), toward popular music, so although the music is deemed to be popular by current standards, depending upon the biasing, the answer from the response generation module may be that it dislikes the song, and so on. In one example, the biasing of the response generation module, e.g., the configuration with training data, may be to predispose the response generation module and impart a perspective of a particular historical culture. Thus, when presented with a challenge query, “is this a good thing?” relating to a picture of a man dancing, the response generation module may have a different answer depending upon the perspective of the particular historical culture.

An example implementation of the present disclosure may proceed as follows. A user, via a client device, may seek to download a financial statement from the user's banking institution. The user may log in to the bank's server via a webpage by entering a username and password. The bank server may instruct or request an integrity server to provide additional security for the communication session. The integrity server may then select a particular response generation module to provide to the client device. The response generation module may be stored and available for selection, or may be generated by the integrity server in response to the communication session and/or the request from the bank server. Notably, the response generation module may comprise a rule-set that is different from rule-sets of other response generation modules that are available for selection (or different from rule-sets of other possible response generation modules that may be created). In one example, the response generation module may be trained to have a particular perspective or bias that is different from perspectives/biases of other response generation modules that are available for selection (or different from perspectives/biases of other possible response generation modules that may be created). In one example, the response generation module may be trained to have a particular limited knowledge base that is different from the knowledge bases of other response generation modules that are available for selection (or different from knowledge bases of other possible response generation modules that may be created).

In one example, the integrity server provides the response generation module to the client device (e.g., as part of a VM package sent to the client device, or to be embedded in a VM instantiated by the client device). The integrity server may then send (e.g., via the nodes of the integrity platform) a video of people and boats sailing. Next, the integrity server may send a challenge query such as: “What do you think these people are doing?” The response generation module may comprise a MLM that is trained to classify images, but may have been trained on a limited data set comprising tagged images of ancient Greek life. The response generation module may therefore generate an answer of “fishing,” whereas the image may more accurately be showing a sailboat race. It should be noted that the present disclosure is not interested in the accuracy of any answers. Rather, it is that the answer is in accordance with the perspective/bias of the particular response generation module, such that the answer from the particular response generation module of the client device matches an expected answer as determined by the integrity server via a retained copy of the particular response generation module (and the challenge file and challenge query as inputs).

As such, if the answer matches the expected answer, the integrity server may confirm to the bank server that the communication session is still secure and allow the client device to access the financial statement. Acceptable answers to periodic challenge questions (and possible new challenge files) may prove that the client device of the legitimate user is truly receiving the data feed of the communication session. For example, another challenge can be dynamically issued if the user attempts to initiate a large monetary transfer to another bank account while currently signed into the current website. Thus, in one embodiment the present disclosure provides a continuous ongoing level of authentication even though the user has been initially authenticated to access the bank account. In fact, in one embodiment, additional layers of response generation modules can be deployed, e.g., accessing the bank account is correlated with a first response generation module, whereas making a monetary transfer of over a pre-defined monetary amount (e.g., $1,000, $5,000, $10,000, etc.) while accessing the bank account will trigger a second different response generation module, and so on. This multi-layers of different response generation modules will further enhance the present verification and/or authentication process.

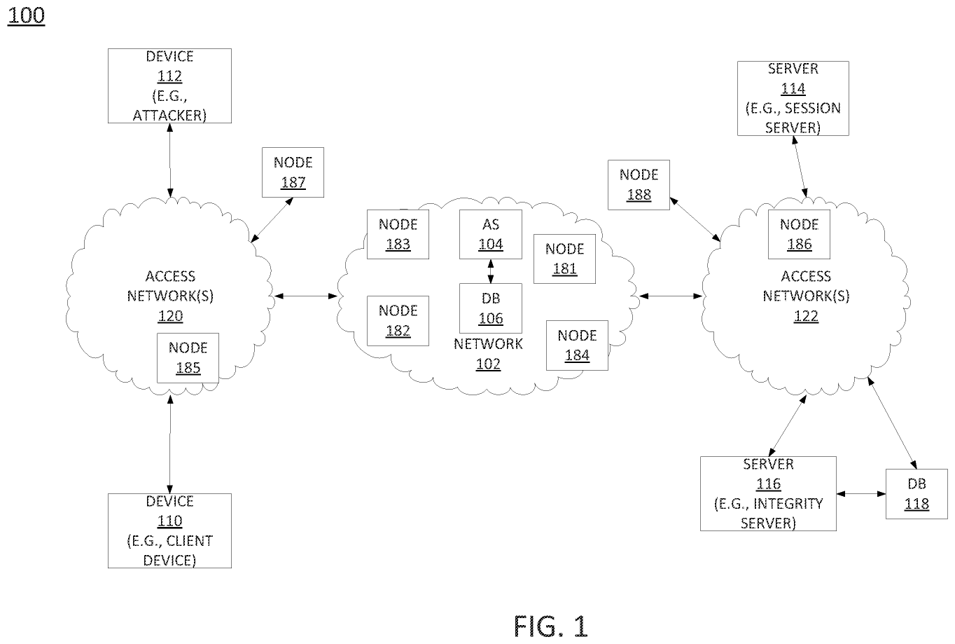

It should be noted that in the above example, even if an attacker obtains the challenge file and the challenge query, it is likely that the attacker will not provide an acceptable response if the attacker does not also possess the response generation module. Rather, the attacker is likely to answer as accurately as possible given a contemporary human perspective and knowledge, e.g., “a sailing race.” These and other aspects of the present disclosure are described in additional detail below in connection with the examples of FIGS. 1-4.

To further aid in understanding the present disclosure, FIG. 1 illustrates an example system 100 in which examples of the present disclosure may operate. The system 100 may include any one or more types of communication networks, such as a traditional circuit switched network (e.g., a public switched telephone network (PSTN)) or a packet network such as an Internet Protocol (IP) network (e.g., an IP Multimedia Subsystem (IMS) network), an asynchronous transfer mode (ATM) network, a wireless network, a cellular network (e.g., 2G, 3G, 4G, 5G and the like), a long term evolution (LTE) network, and the like, related to the current disclosure. It should be noted that an IP network is broadly defined as a network that uses Internet Protocol to exchange data packets. Additional example IP networks include Voice over IP (VoIP) networks, Service over IP (SoIP) networks, and the like.

In one example, the system 100 may comprise a network 102 (e.g., a telecommunication network of a telecommunication service provider). The network 102 may be in communication with one or more access networks 120 and 122, and the Internet (not shown). In one example, network 102 may combine core network components of a cellular network with components of a triple play service network; where triple-play services include telephone services, Internet services and television services to subscribers. For example, network 102 may functionally comprise a fixed mobile convergence (FMC) network, e.g., an IP Multimedia Subsystem (IMS) network. In addition, network 102 may functionally comprise a telephony network, e.g., an Internet Protocol/Multi-Protocol Label Switching (IP/MPLS) backbone network utilizing Session Initiation Protocol (SIP) for circuit-switched and Voice over Internet Protocol (VoIP) telephony services. Network 102 may further comprise a broadcast television network, e.g., a traditional cable provider network or an Internet Protocol Television (IPTV) network, as well as an Internet Service Provider (ISP) network. In one example, network 102 may include a plurality of television (TV) servers (e.g., a broadcast server, a cable head-end), a plurality of content servers, an advertising server (AS), an interactive TV/video-on-demand (VoD) server, and so forth. For ease of illustration, various additional elements of network 102 are omitted from FIG. 1.

In one example, the access networks 120 and 122 may comprise Digital Subscriber Line (DSL) networks, public switched telephone network (PSTN) access networks, broadband cable access networks, Local Area Networks (LANs), wireless access networks (e.g., an IEEE 802.11/Wi-Fi network and the like), cellular access networks, 3^{rd} party networks, and the like. For example, the operator of network 102 may provide a cable television service, an IPTV service, or any other types of telecommunication service to subscribers via access networks 120 and 122. In one example, the access networks 120 and 122 may comprise different types of access networks, may comprise the same type of access network, or some access networks may be the same type of access network and other may be different types of access networks. In one example, the network 102 may be operated by a telecommunication network service provider. The network 102 and the access networks 120 and 122 may be operated by different service providers, the same service provider or a combination thereof, or may be operated by entities having core businesses that are not related to telecommunications services, e.g., corporate, governmental, or educational institution LANs, and the like.

In one example, the access networks 120 may be in communication with one or more devices 110 and 112. Similarly, access networks 122 may be in communication with one or more devices, e.g., servers 114 and 116, database system (DB) 118, etc. Access networks 120 and 122 may transmit and receive communications between devices 110 and 112, servers 114 and 116, application server (AS) 104 and/or other components of network 102, devices reachable via the Internet in general, and so forth. In one example, each of the devices 110 and 112 may comprise any single device or combination of devices that may comprise an endpoint device, e.g., a client device. For example, the devices 110 and 112 may each comprise a mobile device, a cellular smart phone, a laptop, a tablet computer, a desktop computer, a wearable computing device, an application server, a bank or cluster of such devices, an IoT device, and the like. However, it should be noted that in one example, either or both of devices 110 and 112 may instead comprise a cloud desktop, or the like, wherein the “client device” may comprise network-based computing resources that are allocated to a user and which may provide for an operating system and a suite of applications which may provide similar functions to a desktop computer, a laptop computer, a mobile computing device, etc.

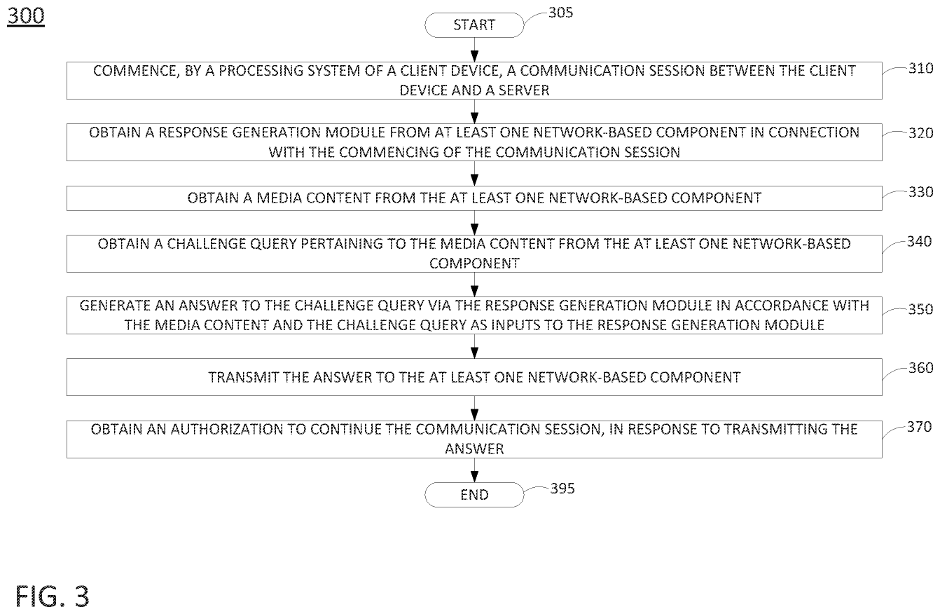

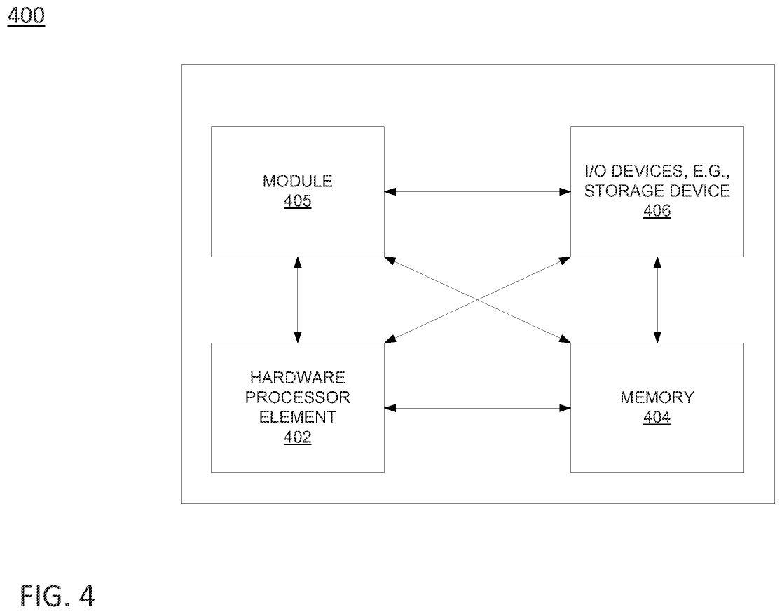

In one example, any one or more of devices 110 and 112 may comprise a computing device or processing system, such as computing system 400 depicted in FIG. 4, and may be configured to provide one or more operations or functions for obtaining an authorization to continue the communication session via an answer to the challenge query via the response generation module in accordance with the media content and the challenge query as inputs. A flowchart of an example method 300 for obtaining an authorization to continue the communication session via an answer to the challenge query via the response generation module in accordance with the media content and the challenge query as inputs is illustrated in FIG. 3 and discussed in greater detail below.

In addition, it should be noted that as used herein, the terms “configure,” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures or the like which may cause a processing system executing computer-readable instructions, code, and/or programs to function differently depending upon the values of the variables or other data structures that are provided. As referred to herein a “processing system” may comprise a computing device, or computing system, including one or more processors, or cores (e.g., as illustrated in FIG. 4 and discussed below) or multiple computing devices collectively configured to perform various steps, functions, and/or operations in accordance with the present disclosure.

In addition, as referred to herein, “configuration code” may comprise computer-readable/computer-executable instructions, or code, which when executed by a processor, or processors, of the processing system within a same device or within distributed devices, may cause the processing system to perform various functions. For example, “configuration code” may include functions, procedures, rules, or the like, and may be expressed in one or more programming languages, and/or may be maintained as one or more binary files (e.g., executables). “Configuration code” may also include variables, data values, tables, objects, libraries, or other data structures or the like which may cause a processing system executing computer-readable instructions/code to function differently depending upon the values of the variables or other data structures that are provided. Configuration code may comprise a package of multiple associated files that when accessed and/or executed by a processing system, cause the processing system to provide a particular function. For instance, in one example, the present disclosure may include providing configuration code from a server to a client device for the instantiation of a specialized VM for deploying a response generation module for communication session integrity verification.

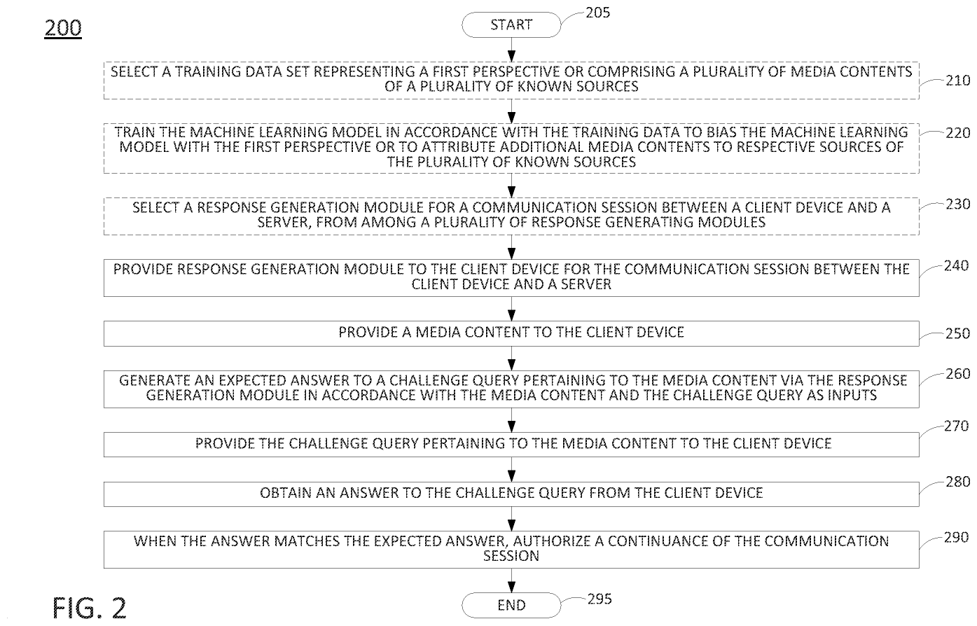

Similarly, servers 114 and 116 may each comprise a computing system or server, such as computing system 400 depicted in FIG.4, and may be configured to provide one or more operations or functions in connection with examples of the present disclosure for authorizing a continuance of a communication session when an answer to a challenge query matches an expected answer that is generated via a response generation module in accordance with a media content and the challenge query as inputs. An example method 200 for authorizing a continuance of a communication session when an answer to a challenge query matches an expected answer that is generated via a response generation module in accordance with a media content and the challenge query as inputs is illustrated in FIG. 2 and described in greater detail below.

To illustrate, server 114 may comprise a “session server” that engages in a communication session with a client device, e.g., device 110, over access network(s) 120 and 122, network 102, etc. The communication session may be established in any manner as noted above, such as the use accessing a webpage to enter a username and password, possible additional entry of a two-factor authentication passcode conveyed to a user of the device 110 (e.g., via SMS message, email, or the like), and so on. In the example of FIG. 1, server 116 may comprise an integrity server that is configured to verify the integrity of ongoing communication sessions using media content/challenge files and/or challenge questions in conjunction with response generation modules that are provided to client devices on a per-session basis. For instance, continuing with the present example, (session) server 114 may request that (integrity) server 116 provide ongoing integrity verification for the communication session with (client) device 110.

In one example, the server 116 may comprise, be coupled to, or otherwise have access to database system (DB) 118, which may store various data in connection with examples of the present disclosure. For instance, database system 118 may store various data that may be used to train response generation modules, may store response generation modules that have been pre-trained and that are ready for selection and deployment to client devices, may store media content that may be used as “challenge files,” may store challenge queries that may be used in connection with particular challenge files and/or general challenge queries that may be applied to media content/challenge files, and so forth. In one example, the data stored by database system 118 may include information regarding demographic characteristics of human reviewers. For instance, reviewers may have previously provided rankings, ratings, scores, or the like with respect to different media content. Alternatively, or in addition, the reviewers may have provided labels, tags, or descriptions for various media content, such as “beach day,” “snowy mountain,” “crowd cheering,” “people talking,” etc. Thus, different media content may be tagged with different ratings by different reviewers, may be labeled with different labels by different reviewers, and so forth. In addition, the reviewers may have provided demographic information, information regarding the preferences and profiles of the reviewers (e.g., prefers classical music, prefers rock music, likes basketball, dislikes football, likes action movies, dislikes science fiction, etc.).

From this pool of information, server 116 may thus create response generation modules having particular perspectives/biases, particular limited knowledge bases, particular rule sets, and so forth. Alternatively, or in addition, response generation modules may be pre-trained, either by server 116, or via a separate processing system, to have a pool of pre-trained response generation modules that are stored in database system 118 and available for selection. In one example, database system 118 may represent a distributed file system, e.g., a Hadoop® Distributed File System (HDFS™), or the like.

In one example, server 116 may include a challenge query generation tool that may include query templates from which full challenge queries may be created. For instance, a query template may be how many times does the word “—” appear on page “—”? The server 116 may select a challenge file, e.g., a document, and randomly select a page from a document, book, etc., extract one or more words which appears at least once on such page, and then plug these values into the template to generate a challenge query. For example, the full challenge query may be: “How many times does the word tree appear on page 72?” In another example, there may be one or more challenge queries pre-stored in association with corresponding media content/challenge files. For instance, a system operator personnel may generate a series of one or more challenge queries for each media content/challenge file, such as the examples above, e.g., “What is this scene?” or “Is this a pleasant day?” It should be noted that the nature of the challenge query may be matched to the capabilities, biases, and/or type of response generation module. For instnace, a rule-set type response generation module may have different types of challenge queries from a limited-knowledge base type response generation module or a biased/unique perspective response generation module.

In any case, the (integrity) server 116 may create and train a response generation module from the information stored in database system 118, or may select a response generation module stored in database system 118, and provide the response generation module to (client) device 110. Next, server 116 may select or otherwise obtain a media content/challenge file from database system 118 and provide this media content to (client) device 110. In addition, server 116 may generate a challenge query, or may select or otherwise obtain a challenge query from database system 118, and provide the challenge query to (client) device 110. In one example, the timing of sending the response generation module, the challenge file, and the challenge query may be configured or selected by an operator of the (integrity) server 116, by the (session) server 114 or an operator thereof, and so forth. For instance, the challenge file may be sent one minute after the response generation module, the first challenge query may be sent one minute thereafter, an additional challenge query may be sent another minute later, and so on.

In one example, the response generation module, the challenge file, and/or the challenge query may be sent by the server 116 via an integrity platform, e.g., a collection of nodes 181-188, which may maintain a distributed ledger (e.g., a blockchain ledger) recording information pertaining to the distribution of the response generation module, the challenge file, and/or the challenge query from the server 116 to the particular device 110. For instance, different pieces of the challenge file may be conveyed to device 110 via different routings through nodes 181-188 and over the access network(s) 120 and 122, network 102, etc. Each of the nodes 181-188 may comprise a physical device, or a physical device operating a VM/VNF, that is configured as a node for distributing response generation modules, challenge files, and/or challenge queries, and/or for maintaining the distributed ledger. The nodes 181-188 may be controlled by a single entity (e.g., the operator of (integrity) server 116 and/or an operator of network 102, or may be controlled by a plurality of different entities.

The (client) device 110, upon receiving the response generation module may deploy the response generation module and wait for a challenge file and at least one challenge query. Upon receiving the challenge file, device 110 may store the challenge file and await the at least one challenge query to follow. In one example, the communication session with server 114 may continue between challenge queries. In another example, each time an additional action is attempted via device 110 during the communication session, a challenge query may be presented and an answer verified by the (integrity) server 116, such as each time a user attempts to navigate from one webpage to another during an online banking session with server 114. When a challenge query is received, the device 110 may apply the challenge file and the challenge query as inputs to the response generation module. The response generation module may generate and answer in accordance with its configuration (e.g., trained perspective/bias, limited knowledge, and/or rule-set) and transmit the answer to the server 116. In one example, the response may also be sent via the integrity platform (e.g., one or more of nodes 181-188).

As described above, the server 116 may maintain or may have access to its own copy of the response generation module. As such, the server 116 may determine an expected answer to the challenge query by applying the challenge query and the challenge file as inputs to the copy of the response generation module to generate an expected answer. Thus, when the answer received from the device 110 matches the expected answer, the server 116 may authorize the communication session to continue. For instance, the server 116 may transmit an instruction to server 114 to allow the communication session to continue. The same process may continue for additional challenge queries over the duration of the communication session. In addition, the server 116 may also choose to send one or more subsequent challenge files/media content, e.g., if the available challenge queries are exhausted for the original challenge file that is sent, or the like.

Notably, an attacker, such a device 112 or a user thereof, may attempt to intercept the communication session and impersonate device 110, e.g., via one or more compromised intermediate devices, such as routers in access networks 120 or 122, etc. However, in order to succeed, the attacker would (in addition to passing other verification mechanisms, such as IP address and/or location check, TLS and/or IPSec keys, knowledge of the integrity server 116), need to obtain the response generation module, the challenge file, and the challenge query. The challenge query may be unanswerable without the challenge file. In addition, even with the challenge file and the challenge query, without the particular rule-set, perspective/bias, or limited knowledge base of the response generation module, the expected answer may be indeterminable.

It should be noted that the foregoing describes just one illustrative scenario of how the system 100 may be used in connection with examples of the present disclosure for obtaining an authorization to continue the communication session via an answer to the challenge query via the response generation module in accordance with the media content and the challenge query as inputs and/or for authorizing a continuance of a communication session when an answer to a challenge query matches an expected answer that is generated via a response generation module in accordance with a media content and the challenge query as inputs. For instance, in one example, server 116 may communicate with device 110 without the use of a multi-node integrity platform (e.g., nodes 181-188). In other words, server 116 may represent the integrity platform and may maintain its own secure session (e.g., a TLS session or the like) with device 110 for purposes of presenting challenge queries and receiving answers thereto, etc. In addition, although described above that device 110 may instantiate a VM to deploy the response generation module, in another example, the response generation module may not necessarily be embedded in a VM. In still another example, the integrity verification functions of server 116 may alternative be deployed at server 114. In other words, server 114 may maintain a communication session with device 110 and may also engage in the session integrity verification process described herein.

In addition, FIG. 1 further illustrates an application server 104 and a database system (DB) 106 in network 102. In this regard, AS 104 may comprise the same or similar components as those of server 114 and/or server 116 and may provide the same or similar functions. Thus, any examples described herein with respect to server 114 and/or server 116 may similarly apply to AS 104, and vice versa. Similarly, database system 106 may store the same or similar information as database system 118, which may be accessible to AS 104 for information storage and retrieval. In addition, in one example, database system 106 may comprise a distribute file system of the same or similar nature as database system 118. For instance, an operator of network 102 may provide a session integrity verification service (e.g., for online banking or other transactions requiring secure access) via AS 104 in accordance with the present disclosure (e.g., in addition to telecommunication services such as TV, phone, internet access, etc., as described above).

It should also be noted that the system 100 has been simplified. Thus, the system 100 may be implemented in a different form than that which is illustrated in FIG. 1, or may be expanded by including additional endpoint devices, access networks, network elements, application servers, etc. without altering the scope of the present disclosure. In addition, system 100 may be altered to omit various elements, substitute elements for devices that perform the same or similar functions, combine elements that are illustrated as separate devices, and/or implement network elements as functions that are spread across several devices that operate collectively as the respective network elements. For example, the system 100 may include other network elements (not shown) such as border elements, routers, switches, policy servers, security devices, gateways, a content distribution network (CDN) and the like. For example, portions of network 102 and/or access networks 120 and 122 may comprise a content distribution network (CDN) having ingest servers, edge servers, and the like. Similarly, although only two access networks 120 and 122 are shown, in other examples, access networks 120 and/or 122 may each comprise a plurality of different access networks that may interface with network 102 independently or in a chained manner. For example, server 114 and server 116 may reach network 102 via different access networks, devices 110 and 112 may reach network 102 via different access networks, and so forth. Thus, these and other modifications are all contemplated within the scope of the present disclosure.

FIG. 2 illustrates a flowchart of an example method 200 for authorizing a continuance of a communication session when an answer to a challenge query matches an expected answer that is generated via a response generation module in accordance with a media content and the challenge query as inputs, in accordance with the present disclosure. In one example, the method 200 is performed by a server, such as server 116, or AS 104 of FIG. 1, or any one or more components thereof, or by any one or more of such servers in conjunction with one another and/or in conjunction with other devices and/or components of system 100 of FIG. 1, e.g., server 114, device 110, nodes 181-188, and so forth. In one example, the steps, functions, or operations of method 200 may be performed by a computing device or processing system, such as computing system 400 and/or hardware processor element 402 as described in connection with FIG. 4 below. For instance, the computing system 400 may represent any one or more components of the system 100 that is/are configured to perform the steps, functions and/or operations of the method 200. Similarly, in one example, the steps, functions, or operations of the method 200 may be performed by a processing system comprising one or more computing devices collectively configured to perform various steps, functions, and/or operations of the method 200. For instance, multiple instances of the computing system 400 may collectively function as a processing system. For illustrative purposes, the method 200 is described in greater detail below in connection with an example performed by a processing system. The method 200 begins in step 205 and may proceed to proceed to optional step 210, optional step 230, or step 240.

At optional step 210, the processing system (e.g., of a server) may select a training data set representing a first perspective/bias and/or may select a training data set comprising a plurality of media contents of a plurality of known sources.

At optional step 220, the processing system may train a response generation module, e.g., a machine learning model/machine learning algorithm, in accordance with the training data to bias the machine learning model with a first perspective and/or to attribute additional media contents to respective sources of the plurality of known sources. For instance, the training data may be associated with a first population demographic for which the same media content may be presented to various subjects/users with the same questions, e.g., challenge queries, asked, such as: “What is in the picture?,” “Caption the picture,” “How many people are in the story?,” “Is the main character happy?,” “Do you like the story?,” “Do you like the song?,” “rate the story from 1-10,” and so forth. The answers may then be collected and stored in association with demographic information regarding all of the various subjects. Then different sub-groups/populations may be generated and organized by, for example, age brackets, region, native language, gender, interests (as self-reported per user consent and anonym ized), etc. The media content and the answers to queries for subjects/users within a demographic group may then be used to train the response generation module (e.g., a MLM) that is biased toward the preferences of that particular demographic group. In one example, the response generation module may comprise a convolutional neural network (CNN) to process the media content combined with a long short term memory to process an output of the CNN and a challenge query. It should be noted that various other types of MLAs and/or MLMs may be implemented in examples of the present disclosure, such as k-means clustering and/or k-nearest neighbor (KNN) predictive models, support vector machine (SVM)-based classifiers, e.g., a binary classifier and/or a linear binary classifier, a multi-class classifier, a kernel-based SVM, etc., a distance-based classifier, e.g., a Euclidean distance-based classifier, or the like, a deep neural network (DNN), a recurrent neural network (RNN), and so on.

In another example, the training data set may comprise music of ten artists chosen at random, eight artists, etc. The response generation module may then be trained to detect/classify which works are by which artist. An additional example may involve an available set of articles by various authors. A set of 10 authors and their representative works may then be used as the training/testing data, with the 10 authors being selected randomly from among a larger pool of authors and their representative works. For instance, the response generation module may comprise a multi-class classifier, e.g., a neural network based classifier, a set of binary classifiers (e.g., such as a set of support vector machine (SVM), one-for each class/category), etc., and so forth. Answers to challenge queries may then comprise an output having a highest score/value from among the respective outputs. For instance, the response generation module may be configured to choose one of the 10 known authors as the most likely creator of another work that was not part of the training/testing data of the response generation module. It is again noted that the work may be by an entirely different author that is not one of the 10 known authors. In an example in which challenge queries are in a natural language format, the response generation module may further include a natural language understanding (NLU) pipeline, such as a LSTM, to obtain an understanding of the challenge query in order to formulate a response. However, on other examples, a formula-based challenge query (having a structured format) may be used, e.g., “How many times does the word—appear on page—of the document,” where there are just two variables.

At optional step 230, the processing system may select a response generation module, from among a plurality of response generating modules, for a communication session between a client device and a server (e.g., a content server, which may be the same or different from a server and/or processing system performing the method 200). In one example, the response generation module may comprise a rule-set to generate an answer in response to inputs comprising a challenge query and a media content, e.g., “count the number of instances of word—on page—of the document”; respond to the query in textual English (e.g., “five” instead of 5, “seven” instead of 7, etc.; respond in textual French, regardless of the language of the challenge query; when receiving a challenge query in Spanish, provide an answer in German; when receiving a challenge query in French, provide an answer in Italian; and so forth.

Alternatively, or in addition, the response generation module may be trained to have a particular perspective or bias that is different from perspectives/biases of other response generation modules that are available for selection (or different from perspectives/biases of other possible response generation modules that may be created via optional steps 210 and 220). In one example, the response generation module may be trained to have a particular limited knowledge base (e.g., only 10 artists are known to the response generation module based on the training/testing data) that is different from the knowledge bases of other response generation modules that are available for selection (or different from limited knowledge bases of other possible response generation modules that may be created via optional steps 210 and 220).

At step 240, the processing system provides a response generation module to a client device for a communication session between the client device and a server. The response generation module may be created and/or selected in accordance with any one or more of optional steps 210-230 and may have any format and/or training/configuration as noted above.

At step 250, the processing system provides a media content to the client device. The media content may be an electronic file comprising one of: an image, a video, a document, a book, an article, a webpage, a song or other audio clips, and so forth. In one example, the media content may be of a same type as training/testing data used to create the response generation module. However, in another example, certain types of media content/challenge files may be of a different format than the training/test data. For instance, the response generation module may be trained on images of paintings, but the challenge file/media content may be a film. A challenge query may then pertain to particular frames, groups of pictures, or the like, from within the film.

At step 260, the processing system generates an expected answer to a challenge query pertaining to the media content via the response generation module in accordance with the media content and the challenge query as inputs. For example, the challenge query may comprise a query as to a source of at least one component of the media content, may comprise an open-ended natural language query, such as “What do you think of this scene?,” “How many people are in the scene?,” “Are the people happy?,” “What is the story about?,” “Who is the main character?,” and so forth. In another example, the query may ask a more focused question regarding an aspect of the media content, e.g., “How many times does the word ‘tree’ appear on page 47?,” “How many times does the word ‘dog’ appear in chapter 10?,” etc. In still another example, the challenge query may be “Which artist created this?”

At step 270, the processing system provides the challenge query pertaining to the media content to the client device. In one example, any or all of steps 240, 250, and/or 270 may comprise sending/transmitting to the client device via an integrity platform comprising a plurality of nodes which may maintain a distributed ledger, e.g., a blockchain ledger, that may record information regarding the communication session, such as client device information, a hash of each challenge file, a hash of each challenge question, a timestamp, host imprints (for VM instantiation), hashed keys, geolocation data, and so forth.

In one example, the response generation module may be biased and/or may have a limited knowledge based (e.g., a training/testing data set may comprise music of ten artists chosen at random). The media content may be a song by an entirely different artist and the challenge query may be: “Which artist is performing this song?” Based upon the limited training of the response generation module, it may attempt to choose one of the ten known artists. Of course the result will be wrong because the identity of the correct artist is completely outside the realm of knowledge of the response generation module. Nevertheless, the response generation module will output a particular answer that is its best guess, given its limited knowledge. In this case, it is not important that the correct artist be determined. Rather, it is sufficient that the processing system has an expected answer and that the response generated via the client device should match the expected answer.

An additional example may involve an available set of articles by various authors. A set of ten authors and their representative works may then be used as the training/testing data, with the ten authors being selected randomly from among a larger pool of authors. Then a media content may comprise an article by a different author and the challenge query may be: “Who wrote this article?” Again, the answer may be incorrect. However, what is important is that the answer from the client device matches the expected answer determined at step 260. Notably, an attacker who somehow is able to access both the media content and the challenge query will likely attempt to answer as correctly as possible by simply looking at an author's name, if present. In contrast, the present method is instead interested in the output of the response generation module based upon its limited training and incomplete knowledge.

As another example, a response generation module may be trained on various paintings of known artists to detect the artist for given a painting. There may be numerous artists from which a small set may be selected for the training and testing. Then the media content may comprise a movie and the challenge query may be: “which artist created the scene at 34:45?” Of course the media content is a film and is not a painting. However, the image from the frame at 34:45 or a composite of several frames may be extracted and the response generation module may attempt to determine, from among the possible artists known to the response generation module, a best match for the image. Multiple challenge queries and responses from the same movie may be formulated in a similar way. In addition, the response and expected response may change depending upon the type of scene, whether it is an outdoor vista, an indoor scene, a character close up, a dialogue scene, an action sequence, etc.

At step 280, the processing system obtains an answer to the challenge query from the client device. For instance, the client device may apply the media content/challenge file and the challenge query to the response generation module, and may obtain an answer/output therefrom in the same or a similar manner as the processing system obtains the expected answer at step 260. In one example, the processing system may obtain the answer from the client device via the integrity platform, e.g., the plurality of nodes maintaining the distributed ledger.

At step 290, the processing system authorizes a continuance of the communication session, when the answer matches the expected answer. For instance, in an example where the processing system does not include the session server engaged in the communication session with the client device, the processing system may transmit a notification to the session server that the communication session is permitted to continue.

Following step 290, the method 200 proceeds to step 295. At step 295 the method 200 ends.

It should be noted that the method 200 may be expanded to include additional steps, or may be modified to replace steps with different steps, to combine steps, to omit steps, to perform steps in a different order, and so forth. For instance, in one example the processing system may repeat one or more steps of the method 200, such as steps 260-290 for additional challenge queries, e.g.: generating an additional challenge query, generating an additional expected answer to the additional challenge query via the challenge response module in accordance with the media content and the additional challenge query as additional inputs, transmitting the additional challenge query to the client device, obtaining an additional answer to the additional challenge query from the client device, re-authorizing the continuance of the communication session, when the additional answer matches the additional expected answer, and so forth. Similarly, steps 250-290 may be repeated to update the media content/challenge file against which challenge queries are to be answered, steps 230-290 or steps 240-290 may be repeated for a different communication session with a different client device and/or a different session server, and so on. In one example, step 270 may be performed prior to step 260, or prior to step 240. It should be noted that insofar as some challenge questions may be yes/no, in one example, multiple challenge questions and challenge responses may be applied in a single verification instance of steps 270 and 280, or steps 260-280. Thus, these and other modifications are all contemplated within the scope of the present disclosure.

FIG. 3 illustrates a flowchart of an example method 300 for obtaining an authorization to continue the communication session via an answer to the challenge query via the response generation module in accordance with the media content and the challenge query as inputs, in accordance with the present disclosure. In one example, the method 300 is performed by a client device, such as device 110 of FIG. 1, or any one or more components thereof, or by client device 110 in conjunction with other devices and/or components of system 100 of FIG. 1, e.g., server 114, server 116, and so forth. In one example, the steps, functions, or operations of method 300 may be performed by a computing device or processing system, such as computing system 400 and/or hardware processor element 402 as described in connection with FIG. 4 below. For instance, the computing system 400 may represent any one or more components of the system 100 that is/are configured to perform the steps, functions and/or operations of the method 300. Similarly, in one example, the steps, functions, or operations of the method 300 may be performed by a processing system comprising one or more computing devices collectively configured to perform various steps, functions, and/or operations of the method 300. For instance, multiple instances of the computing system 400 may collectively function as a processing system. For illustrative purposes, the method 300 is described in greater detail below in connection with an example performed by a processing system. The method 300 begins in step 305 and proceeds to step 310.

At step 310, the processing system (e.g., of a client device) commences a communication session between the client device and a server. For instance, the communication session may be established in any manner as noted above, such as the use accessing a webpage to enter a username and password, possible additional entry of a two-factor authentication passcode conveyed to a user of the device 110 (e.g., via SMS message, email, or the like), and so on.

At step 320, the processing system obtains a response generation module from at least one network-based component in connection with the commencing of the communication session. For instance, the response generation module may be obtained via an integrity platform comprising at least an integrity server (e.g., where the integrity server sends the response generation module per step 240 of the example method 200, discussed above). In one example, the integrity platform may further comprise a plurality of nodes maintaining a distributed blockchain ledger. In one example, the response generation module operates in a virtual machine instantiated on the client device. In one example, the response generation module comprises a rule-set to generate an answer in response to inputs comprising a challenge query and a media content. Alternatively, or in addition, in one example, the response generation module comprises a machine learning model (MLM). For instance, the machine learning model may comprise a convolutional neural network (CNN) to process the media content combined with a long short term memory to process an output of the CNN and a challenge query. In addition, in one example the response generation module may be biased with a first perspective in accordance with a first set of training data. It should again be noted that the response generation module may be specific to the communication session, where for an additional communication session between the same or a different client device and a same or a different server, a different response generation module may be used, where the different response generation module is biased with a second perspective in accordance with a second set of training data, and where the second perspective is different from the first perspective. The response generation module may take any form and have any configuration that is the same or similar as discussed above in connection with the example method 200 of FIG. 2, or as described elsewhere herein.

At step 330, the processing system obtains a media content from the at least one network-based component. For instance, the media content may be an electronic file comprising one of: an image, a video, a document, a book, an article, a webpage, a song or other audio clip, and so forth.

At step 340, the processing system obtains a challenge query pertaining to the media content from the at least one network-based component. For instance, the challenge query may be of the same or similar nature as described above in connection with the example method 200 of FIG. 2. In one example, the challenge query may be in a natural language format. As noted above, the at least one network-based component (e.g., an integrity platform) may further comprise a plurality of nodes maintaining a distributed blockchain ledger. In such case, the blockchain ledger may maintain records of a transmission of the media content and the challenge query to the client device. In an example where the response generation module operates in a virtual machine instantiated on the client device, the media content and the challenge query may be received via the virtual machine at steps 330 and 340.

At step 350, the processing system generates an answer to the challenge query via the response generation module in accordance with the media content and the challenge query as inputs to the response generation module. For instance, the response generation module may process the inputs to generate an output in accordance with the configuration and/or training of the response generation module. For instance, step 350 may comprise similar operations as step 260 of the example method 200 of FIG. 2.

At step 360, the processing system transmits the answer to the at least one network-based component. The transmitting may be via an integrity network, e.g., a plurality of nodes, and/or may be via a separate secure session (e.g., a TLS session or the like) between the client device and the at least one network-based component.

At step 370, the processing system obtains an authorization to continue the communication session, in response to transmitting the answer. For instance, the answer may be determined by the at least one network-based component to match an expected answer, in which case the at least one network-based component may authorize the communication session to continue. The client device may thus continue to obtain data from the server during the communication session.

Following step 370, the method 300 proceeds to step 395. At step 395 the method 300 ends.

It should be noted that the method 300 may be expanded to include additional steps, or may be modified to replace steps with different steps, to combine steps, to omit steps, to perform steps in a different order, and so forth. For instance, in one example the processing system may repeat one or more steps of the method 300, such as steps 340-370 for additional challenge queries, e.g.: obtaining an additional challenge query from the at least one component of the communication network network-based component, generating an additional answer to the additional challenge query via the challenge response module in accordance with the media content and the additional challenge query as additional inputs, transmitting the additional answer to the at least one component of the communication network network-based component, obtaining an additional authorization to continue the communication session, in response to transmitting the additional answer, e.g., where the additional answer is an additional expected answer that is expected by the at least one component of the communication network network-based component, and so forth. Similarly, steps 330-370 may be repeated to obtain a new media content/challenge file against which challenge queries are to be answered, steps 310-370 may be repeated for a different communication session with a same or a different session server, and so on. It should be noted that insofar as some challenge questions may be yes/no, in one example, multiple challenge questions and challenge responses may be applied in a single verification instance of steps 340 and 350. Thus, these and other modifications are all contemplated within the scope of the present disclosure.

In addition, although not expressly specified above, one or more steps of the method 200 or the method 300 may include a storing, displaying and/or outputting step as required for a particular application. In other words, any data, records, fields, and/or intermediate results discussed in the respective methods can be stored, displayed and/or outputted to another device as required for a particular application. Furthermore, operations, steps, or blocks in FIGS. 2 and 3 that recite a determining operation or involve a decision do not necessarily require that both branches of the determining operation be practiced. In other words, one of the branches of the determining operation can be deemed as an optional step. Furthermore, operations, steps or blocks of the above described method(s) can be combined, separated, and/or performed in a different order from that described above, without departing from the example embodiments of the present disclosure.

FIG. 4 depicts a high-level block diagram of a computing system 400 (e.g., a computing device or processing system) specifically programmed to perform the functions described herein. For example, any one or more components or devices illustrated in FIG. 1, or described in connection with FIGS. 2-3, may be implemented as the computing system 400. As depicted in FIG. 4, the computing system 400 comprises a hardware processor element 402 (e.g., comprising one or more hardware processors, which may include one or more microprocessor(s), one or more central processing units (CPUs), and/or the like, where the hardware processor element 402 may also represent one example of a “processing system” as referred to herein), a memory 404, (e.g., random access memory (RAM), read only memory (ROM), a disk drive, an optical drive, a magnetic drive, and/or a Universal Serial Bus (USB) drive), a module 405 for obtaining an authorization to continue the communication session via an answer to the challenge query via the response generation module in accordance with the media content and the challenge query as inputs or for authorizing a continuance of a communication session when an answer to a challenge query matches an expected answer that is generated via a response generation module in accordance with a media content and the challenge query as inputs, and various input/output devices 406, e.g., a camera, a video camera, storage devices, including but not limited to, a tape drive, a floppy drive, a hard disk drive or a compact disk drive, a receiver, a transmitter, a speaker, a display, a speech synthesizer, an output port, and a user input device (such as a keyboard, a keypad, a mouse, and the like).

Although only one hardware processor element 402 is shown, the computing system 400 may employ a plurality of hardware processor elements. Furthermore, although only one computing device is shown in FIG. 4, if the method(s) as discussed above is implemented in a distributed or parallel manner for a particular illustrative example, e.g., the steps of the above method(s) or the entire method(s) are implemented across multiple or parallel computing devices, then the computing system 400 of FIG. 4 may represent each of those multiple or parallel computing devices. Furthermore, one or more hardware processor elements (e.g., hardware processor element 402) can be utilized in supporting a virtualized or shared computing environment. The virtualized computing environment may support one or more virtual machines which may be configured to operate as computers, servers, or other computing devices. In such virtualized virtual machines, hardware components such as hardware processors and computer-readable storage devices may be virtualized or logically represented. The hardware processor element 402 can also be configured or programmed to cause other devices to perform one or more operations as discussed above. In other words, the hardware processor element 402 may serve the function of a central controller directing other devices to perform the one or more operations as discussed above.

It should be noted that the present disclosure can be implemented in software and/or in a combination of software and hardware, e.g., using application specific integrated circuits (ASIC), a programmable logic array (PLA), including a field-programmable gate array (FPGA), or a state machine deployed on a hardware device, a computing device, or any other hardware equivalents, e.g., computer-readable instructions pertaining to the method(s) discussed above can be used to configure one or more hardware processor elements to perform the steps, functions and/or operations of the above disclosed method(s). In one example, instructions and data for the present module 405 for obtaining an authorization to continue the communication session via an answer to the challenge query via the response generation module in accordance with the media content and the challenge query as inputs or for authorizing a continuance of a communication session when an answer to a challenge query matches an expected answer that is generated via a response generation module in accordance with a media content and the challenge query as inputs (e.g., a software program comprising computer-executable instructions) can be loaded into memory 404 and executed by hardware processor element 402 to implement the steps, functions or operations as discussed above in connection with the example method(s). Furthermore, when a hardware processor element executes instructions to perform operations, this could include the hardware processor element performing the operations directly and/or facilitating, directing, or cooperating with one or more additional hardware devices or components (e.g., a co-processor and the like) to perform the operations.

The processor (e.g., hardware processor element 402) executing the computer-readable instructions relating to the above described method(s) can be perceived as a programmed processor or a specialized processor. As such, the present module 405 for obtaining an authorization to continue the communication session via an answer to the challenge query via the response generation module in accordance with the media content and the challenge query as inputs or for authorizing a continuance of a communication session when an answer to a challenge query matches an expected answer that is generated via a response generation module in accordance with a media content and the challenge query as inputs (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. Furthermore, a “tangible” computer-readable storage device or medium may comprise a physical device, a hardware device, or a device that is discernible by the touch. More specifically, the computer-readable storage device or medium may comprise any physical devices that provide the ability to store information such as instructions and/or data to be accessed by a processor or a computing device such as a computer or an application server.

While various examples have been described above, it should be understood that they have been presented by way of example only, and not limitation. Thus, the breadth and scope of a preferred example should not be limited by any of the above-described examples, but should be defined only in accordance with the following claims and their equivalents.

What is claimed is:

1. A method comprising:
providing, by a processor, a response generation module to a client device for a communication session between the client device and a server;
providing, by the processor, a media content to the client device;
generating, by the processor, an expected answer to a challenge query pertaining to the media content via the response generation module in accordance with the media content and the challenge query as inputs;
providing, by the processor, the challenge query pertaining to the media content to the client device;
obtaining, by the processor, an answer to the challenge query from the client device; and
when the answer matches the expected answer, authorizing, by the processor, a continuance of the communication session.

2. The method of claim 1, further comprising:
selecting the response generation module for the communication session between the client device and the server, from among a plurality of response generating modules.

3. The method of claim 2, wherein the response generation module comprises a rule-set to generate the answer in response to inputs comprising the challenge query and the media content.

4. The method of claim 3, wherein the response generation module comprises a machine learning model.

5. The method of claim 4, wherein the machine learning model comprises a convolutional neural network to process the media content combined with a long short term memory to process an output of the convolutional neural network and the challenge query.

6. The method of claim 4, wherein the response generation module is biased with a first perspective in accordance with a first set of training data.

7. The method of claim 4, further comprising:
selecting a training data set representing a first perspective; and
training the machine learning model in accordance with the training data set to bias the machine learning model with the first perspective.

8. The method of claim 4, further comprising:
selecting a training data set comprising a plurality of media contents of a plurality of known sources; and
training the machine learning model in accordance with the training data set to attribute additional media contents to respective sources of the plurality of known sources.

9. The method of claim 8, wherein the challenge query comprise a query as to a source of at least one component of the media content.

10. The method of claim 1, further comprising:
generating an additional challenge query;
generating an additional expected answer to the additional challenge query via the response generation module in accordance with the media content and the additional challenge query as additional inputs; and
transmitting the additional challenge query to the client device.

11. The method of claim 10, further comprising:
obtaining an additional answer to the additional challenge query from the client device; and
when the additional answer matches the additional expected answer, re-authorizing the continuance of the communication session.

12. An apparatus comprising:
a processing system including at least one processor; and
a computer-readable medium storing instructions which, when executed by the processing system, cause the processing system to perform operations, the operations comprising:
providing a response generation module to a client device for a communication session between the client device and a server;
providing a media content to the client device;
generating an expected answer to a challenge query pertaining to the media content via the response generation module in accordance with the media content and the challenge query as inputs;
providing the challenge query pertaining to the media content to the client device;
obtaining an answer to the challenge query from the client device; and
when the answer matches the expected answer, authorizing a continuance of the communication session.

13. A method comprising:
commencing, by a processing system of a client device, a communication session between the client device and a server;
obtaining, by the processing system, a response generation module from at least one network-based component in connection with the commencing of the communication session;
obtaining, by the processing system, a media content from the at least one network-based component;
obtaining, by the processing system, a challenge query pertaining to the media content from the at least one network-based component;
generating, by the processing system, an answer to the challenge query via the response generation module in accordance with the media content and the challenge query as inputs to the response generation module;
transmitting, by the processing system, the answer to the at least one network-based component; and
obtaining, by the processing system, an authorization to continue the communication session, in response to the transmitting the answer.

14. The method of claim 13, wherein the answer is an expected answer that is expected by the at least one network-based component.

15. The method of claim 13, wherein the media content comprises an electronic file comprising one of:
an image;
a video;
a document;
a book;
an article;
a webpage; or
an audio clip.

16. The method of claim 13, wherein the challenge query is in a natural language format.

17. The method of claim 13, wherein the response generation module comprises a rule-set to generate the answer in response to inputs comprising the challenge query and the media content.

18. The method of claim 13, wherein the response generation module comprises a machine learning model.

19. The method of claim 18, wherein the machine learning model comprises a convolutional neural network to process the media content combined with a long short term memory to process an output of the convolutional neural network and the challenge query.

20. The method of claim 18, wherein the response generation module is biased with a first perspective in accordance with a first set of training data.
